(19) United States
(12) Patent Application Publication
(10) Pub. No.: US 2016/0230966 A1
(43) Pub. Date: Aug. 11, 2016

(54) HOLIDAY LIGHTING AND INTERNALLY LIGHTED ORNAMENTS AND SYSTEMS AND METHODS FOR SHIPPING AND STORING LIGHTING AND ORNAMENTS

(71) Applicants: Frank Thomas DeFrancesco, Henderson, NV (US); Frank T. DeFrancesco, III, Henderson, NV (US)

(72) Inventors: Frank Thomas DeFrancesco, Henderson, NV (US); Frank T. DeFrancesco, III, Henderson, NV (US)

(21) Appl. No.: 15/014,913

(22) Filed: Feb. 3, 2016

Related U.S. Application Data
(60) Provisional application No. 62/112,488, filed on Feb. 5, 2015.

(51) Int. Cl. F21V 17/04; F21V 3/02; F21S 4/10

(52) U.S. Cl. CPC F21V 17/04; F21S 4/10; F21V 3/02; F21W 2121/00

(57) ABSTRACT

A strand of holiday lights includes a plurality of lights connected by at least one wire, and a plurality of ornaments. The ornaments includes a body having an outer surface and an inner surface defining a hollow interior. The ornaments are at least partially transparent and are configured to be releasably separable into two halves. When the ornaments are separated, they may receive at least one light of the plurality lights. The ornament may then close over the light and releasably hold the light within the hollow space to internally light the ornament. When the strand of lights is not in use, the ornaments are configured to be nested together in a stored condition.

### BACKGROUND

1. Field

The disclosed embodiments relate to decorations. More specifically, the disclosed embodiments relate to decorative lighting, such as holiday lighting, and internally lighted ornaments as well as and systems and methods for shipping and storing decorative lights and ornaments.

2. Related Art

Decorative lighting during holidays or other events is commonly displayed by businesses and home owners alike. Many people find such decorative lighting to substantially add to the ambience of their environment and feel that such lighting adds to the enjoyment of a holiday season. Commonly, such businesses and home owners may place lighting on structures such as stores, offices, and homes, as well as on trees and shrubbery.

In addition to lighting, further decor is often employed. Popular decorations in addition to decorative lighting are ornaments. During the Christmas holiday, for example, many people place decorative lighting and ornaments on natural or artificial evergreen trees. Ornaments may also be used during other holidays such as jack-o-lantern ornaments for Halloween, egg-shaped ornaments for Easter, and so forth.

As one type of decoration, there may be an ornament which is internally lighted. This combines the benefits of holiday lighting and ornaments by making an ornament appear to glow from the inside.

However, such internally lighted ornaments have a number of drawbacks, and thus have not obtained widespread use. For example, internally lighted ornaments are difficult to manufacture such that a light is embedded within the ornament. The light embedded therein must either be battery powered, or the ornament must also have wiring embedded throughout to power the light. Further, once made, such ornaments are cumbersome for shipping and storage due to the light and wiring embedded therein, raising the cost of such ornaments for manufacturers and retailers. For similar reasons, business and home owners may be discouraged from using them for lack of storage space. Additionally, such ornaments are hard to service if a light goes out because the light is embedded within the ornament.

### SUMMARY

Given the foregoing drawbacks, there is a need for decorative lighting with internally lighted ornaments that is not cumbersome and that is easily shipped and stored. The disclosed embodiments have been developed in light of the above, and aspects of the invention may include a strand of holiday lights including a plurality of lights connected by at least one wire, and a plurality of ornaments. The ornaments may include a body having an outer surface and an inner surface defining a hollow interior. The ornaments may be at least partially transparent and may be configured to be releasably separable into two halves. When the ornaments are separated, they may receive at least one light of the plurality lights therein. The ornament may then close over the light and releasably hold the light within the hollow space to internally light the ornament. When the strand of lights is not in use, the ornaments may be configured in the open position to be nested together in a stored arrangement.

Other aspects of the invention may include an ornament having a connecting projection that extends from the ornament to hold the light within the ornament and to suspend the internally lighted ornament from the strand of decorative lights. The ornament may further include a hinge that facilitates the opening and closing of the ornament when the ornament is separated into two halves. The ornament may also include one or more connectors such as a latch, magnets, threads, an adhesive, or the like to releasably open and close the halves of the ornament.

Further aspects of the invention may include apertures to facilitate the wiring from the strand of lights. In this embodiment, the light within the ornament may be suspended by the wires of the strand of lights that pass through the apertures of the ornaments. The apertures may be formed by cutouts on connecting surfaces of at least one of the two halves of the ornaments which define the apertures in the closed position. In this manner, the ornament can close over wires of the strand of decorative lighting.

Other aspects of the invention may include ornaments of various shapes and sizes suitable for different holidays, events, or user preferences. The ornaments may be suspended from lights in the strand of holiday lights or may be suspended from the wiring of the strand of holiday lights. Further, the ornaments may include connectors to directly attach one of the ornaments to a tree or other structure. The connectors may also be utilized to allow the ornaments to be hung without being internally lighted. This further increases the versatility of the ornaments.

In some embodiments of the invention, the ornaments may further comprise a connecting projection extending from the outer surfaces of the ornaments. A cap may be attached over the connecting projection. The cap may receive and hold the embedded light within the hollow space. The cap may also comprise a hanger attached to a top portion thereof. The hanger may be utilized to suspend the ornament from another object.

In some embodiments, the two halves of the ornament are releasably connected by a magnetic connection. In other instances, the two halves are connected by a latching connection. The two halves may optionally be joined by, and be movable about, a hinge.

According to additional embodiments, an internally lit ornament may include an at least partially translucent ornament body having an outer surface and an inner surface, the inner surface defining a hollow space. The ornament body may be separated into two halves. The ornament further may have at least one aperture configured to receive at least one wire connecting to a light. The hollow space of the ornament is configured to receive the light therein. At least one connector may be configured to releasably connect the two halves. When the two halves of the ornament are connected together by the connecter, they retain the light within the hollow space. When the two halves are released by the connector, they may be configured to nest within other ornament halves.

In some embodiments, a connecting projection may extend from the outer surface of the ornament body. The light may held within the connecting projection, and the at least one aperture may be disposed in a top of the projection connection. In other embodiments, the at least one aperture is formed by a cutout in at least one of the two halves of the ornament body. Here, the at least one aperture may include two apertures disposed on opposite sides of the connecting projection.

A cap may be configured to cover the connecting projection in some embodiments of the invention. The hanger in some instances may connect to the cap. In some embodiments, the at least one aperture may include two apertures where the apertures are configured to suspend the light from the wire within the hollow space.

According to some embodiments, an opaque coating may partially cover the at least partially translucent ornament body. The ornament body may take on a variety of shapes such as a spherical shape when it is in the closed position. An optional hinge may connect the two halves of the ornament body. The releasable connector connecting the two halves may be a latching connection.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 shows a strand of holiday lighting with internally lighted ornaments, according to an exemplary embodiment.

FIG. 2A shows a front view of an internally lighted ornament, according to an exemplary embodiment.

FIG. 2B shows a front view of an internally lighted ornament in an open configuration, according to an exemplary embodiment.

FIG. 2C shows a top view of an internally lighted ornament shown in FIG. 2B, according to an exemplary embodiment.

FIG. 3 shows a view of decorative lighting and internally lighted ornaments in a stored condition, according to an exemplary embodiment.

FIGS. 4A-4Q show examples of internally lighted ornaments according to various embodiments of the invention. FIG. 4A shows an internally lighted ornament in an open configuration with a latch-type connector. FIG. 4B shows the internally lighted ornament of FIG. 4A in a closed configuration. FIG. 4C shows an internally lighted ornament in an open configuration with a magnetic connector. FIG. 4D shows the internally lighted ornament of FIG. 4C in a closed configuration. FIG. 4E shows an internally lighted ornament in an open configuration with apertures. FIG. 4F shows the internally lighted ornament of FIG. 4E in a closed configuration. FIG. 4G shows internally lighted ornaments with apertures for wiring. FIG. 4H shows internally lighted ornaments in an egg-type shape with a threaded connector. FIG. 4I shows internally lighted ornaments in a hat-shaped configuration. FIG. 4J shows internally lighted ornaments in a bell-shaped configuration. FIG. 4K shows internally lighted ornaments in a star-shaped configuration. FIG. 4L shows internally lighted ornaments in a strawberry-shaped configuration. FIG. 4M shows internally lighted ornaments in an icicle-shaped configuration. FIG. 4N shows internally lighted ornaments in a cube-shaped configuration. FIG. 4O shows internally lighted ornament in a decorative, diamond-shaped configuration. FIG. 4P shows internally lighted ornaments in a cloud-shaped configuration. FIG. 4Q shows an internally lighted ornament in a snowman-shaped configuration.

FIGS. 5A-5F show internally lighted ornaments with hanging connectors according to various embodiments. FIG. 5A shows an internally lighted ornament with a plug connector. FIG. 5B shows an enlarged view of the plug connector shown in FIG. 5A. FIG. 5C shows an exemplary installation of a plug connector shown in FIGS. 5A and 5B. FIG. 5D shows another exemplary embodiment of a plug type hanging connector. FIG. 5E shows a cap hanging connector according to an exemplary embodiment. FIG. 5F shows a hanging connector with internal wiring according to an exemplary embodiment.

FIGS. 6A-6C show an alternative plug-type connector according to an exemplary embodiment. FIG. 6A shows a plug-type connector with an internally lighted ornament. FIG. 6B shows a close up view of the plug-type connector according to FIG. 6A. FIG. 6C shows the plug type connector of FIGS. 6A and 6B with internal lighting omitted.

FIGS. 7A and 7B show an alternative plug-type hanging connector according to an exemplary embodiment. FIG. 7A shows a plug type connector within an ornament. FIG. 7B shows a close up view of the plug-type connector of FIG. 7A.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

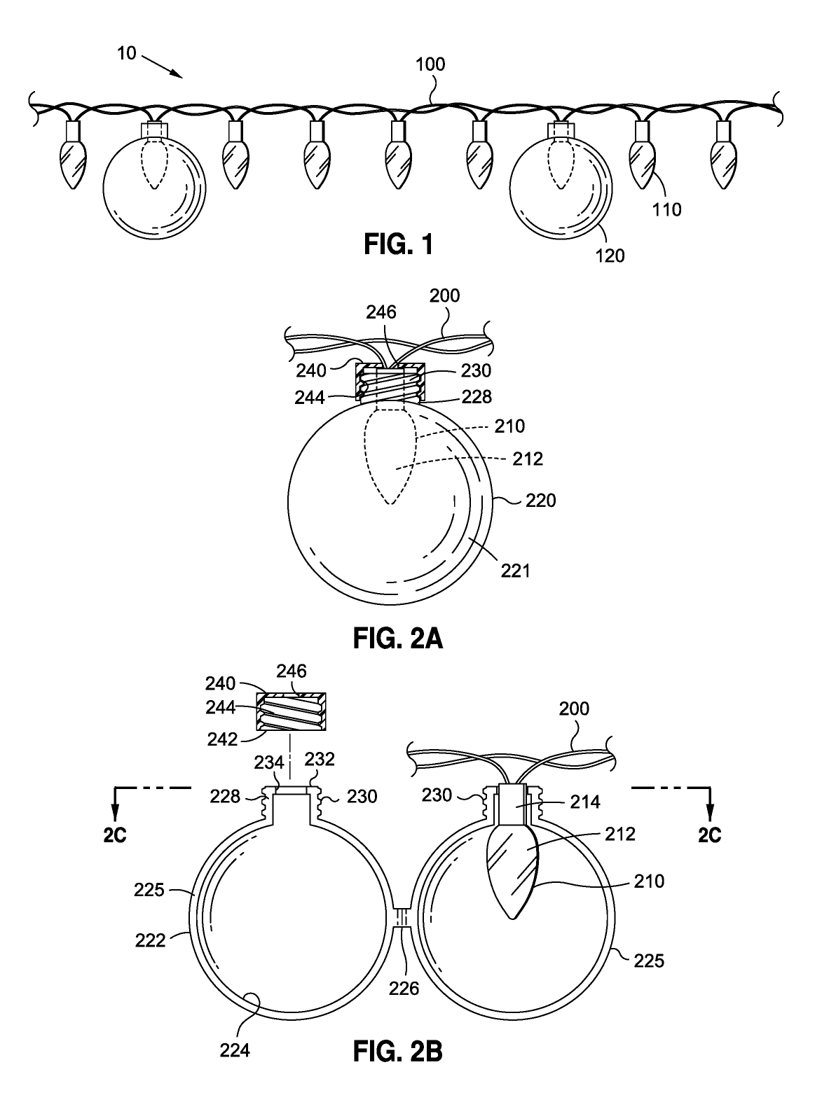

FIG. 1 shows a strand of holiday lighting with internally lighted ornaments, according to an exemplary embodiment. In FIG. 1, a strand of holiday lights 10 includes wiring 100, a plurality of lights 110, and internally lighted ornaments 120. The plurality of lights 110 may be of any desirable size and color based on a user's preference. The lights may be for any holiday, or may simply be for decoration, and may be configured to be installed on buildings, trees, and the like. The strand of holiday lights 10 may have internally lighted ornaments 120 installed over one or more lights 110 in a random or periodic pattern, or the strand of holiday lights may be configured such that each light 110 is covered by an ornament 120.

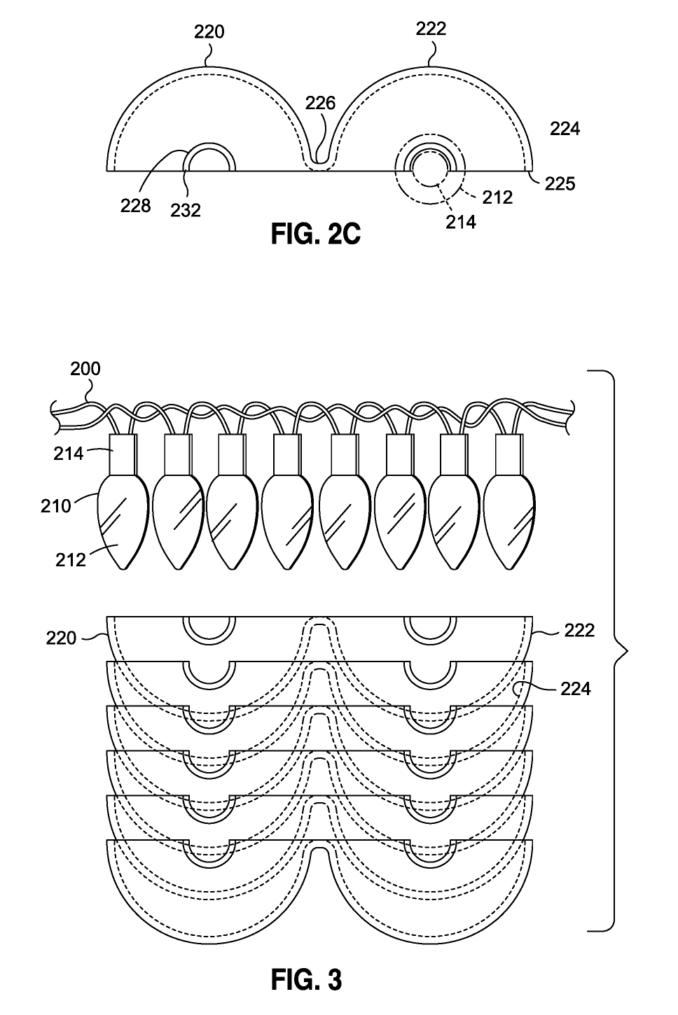

FIG. 2A shows a front view of an internally lighted ornament, according to an exemplary embodiment. The internally lighted ornament 220 comprises an ornament body 221 and a connecting projection 228. The ornament body 221 is comprised of an at least partially transparent material. In another alternative, the ornament body 221 may be formed of a completely transparent material that has an at least partially transparent coating. The ornament body may be configured to be colored, to include patterns, to have a “frosted” effect, or to be decorated in any other such manner according to a user's preference. In this embodiment, the ornament 220 is shaped in a spherical manner. The ornament, however, may take on any variety of shapes, some of which will be explained in more detail below.

The connecting projection 228 extends from an outside surface of the ornament body 221. In this embodiment, the connecting projection 228 facilitates the insertion of one of the lights 210 of a strand 200 of holiday lights into the ornament 220. The connecting projection 228 may also facilitate the hanging of the ornament 220 from a tree or other structure, as will be described in more detail below.

The ornament 220 may further comprise a cap 240. The cap 240 may be formed in a cylindrical shape to cover the projection 228. In some embodiments, the projection 228 may be include threads 230 that interface with internal threads 244 of the cap 240. The cap may include an opening 246 in a top portion thereof to facilitate the light 210. In some embodiments, the light 210 may be a size C9, C7, or other commonly available size, and the opening 246 may be sized to facilitate the light 210. In other embodiments, the cap may have a connector on a top surface for attaching a hook so as to be able to hang the ornament 220 with the light 210 embedded therein.

FIG. 2B shows a front view of an internally lighted ornament in an open configuration, and FIG. 2C shows a top view of an internally lighted ornament shown in FIG. 2B, according to an exemplary embodiment. In this embodiment, the internally lighted ornament opens into two halves. The two halves may be connected by a hinge 226. The hinge 226 may be comprised of a flexible material, such as a plastic material, or may be any other hinge now known or later developed. In this embodiment, the ornament body 221 comprises an outer surface 222 and an inner surface 224. The inner surface 224 of the ornament body 221 defines a hollow space within the ornament 220 in which the lamp 212 of the light 210 may be positioned.

In the embodiment shown in FIGS. 2B and 2C, the connecting projection 228 includes a flange 234 that extends inwardly from top surface 232 of the connecting projection 228. The flange 234 may act as a retaining device when the ornament 220 is placed into the closed position to retain the light 212 within the ornament 220. Specifically, the flange 234 may close around a base 214 of a light 210. The base 214 of the light 210 may also include a corresponding rib or projection about its circumference to retain the base 214 and lightbulb 212 of the light 210 within the ornament, thereby internally lighting the ornament 220. In another embodiment, the flange may be sized as a standard light clip for any one of a standard sized decorative light. To provide further security, the cap 240 may be placed such that the open lower portion 242 of the cap is placed over the projection to secure the ornament 220 in a closed position and secure the light 210 in place.

The ornament body 221 further includes two connection surfaces 225. The connection surfaces 225 come into contact with one another when the two halves of the ornament body 221 are brought together so that the ornament 220 is in the closed position. The connection surfaces 225 may facilitate a releasable connection between the two halves of the ornament body. Various connections may be used, some of which will be described in more detail below.

FIG. 3 shows a view of decorative lighting and internally lighted ornaments in a stored condition, according to an exemplary embodiment. When ornaments 220 in the strand of decorative lights 200 are in the opened position, the strand of decorative lighting 200 may be easily stored and shipped. In one embodiment, once the ornaments are in the opened position, the lights 210 may be easily removed from the ornaments and stored together in a compact fashion.

Further, in this embodiment, the ornaments 220 are configured to nest within one another. Specifically, when in the open position, the outer surface 222 of one ornament 220 is configured to rest on an inner surface 224 of another ornament 220. Thus, the lights 210 of the strand 100 and the ornaments 220 of the strand 200 may be stored in a compact, efficient manner. This allows a manufacturer and retailer to decrease inventory and shipping costs, and allows an end user to decrease storage space when the strand 200 and ornaments 220 are not in use.

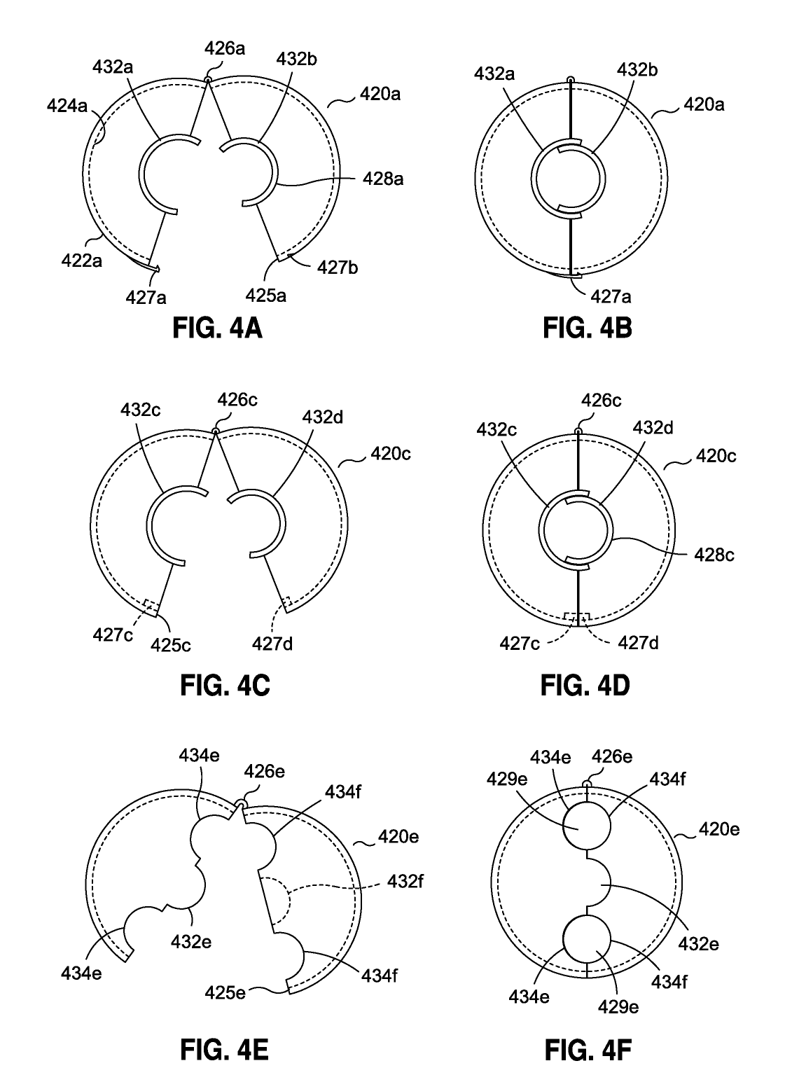

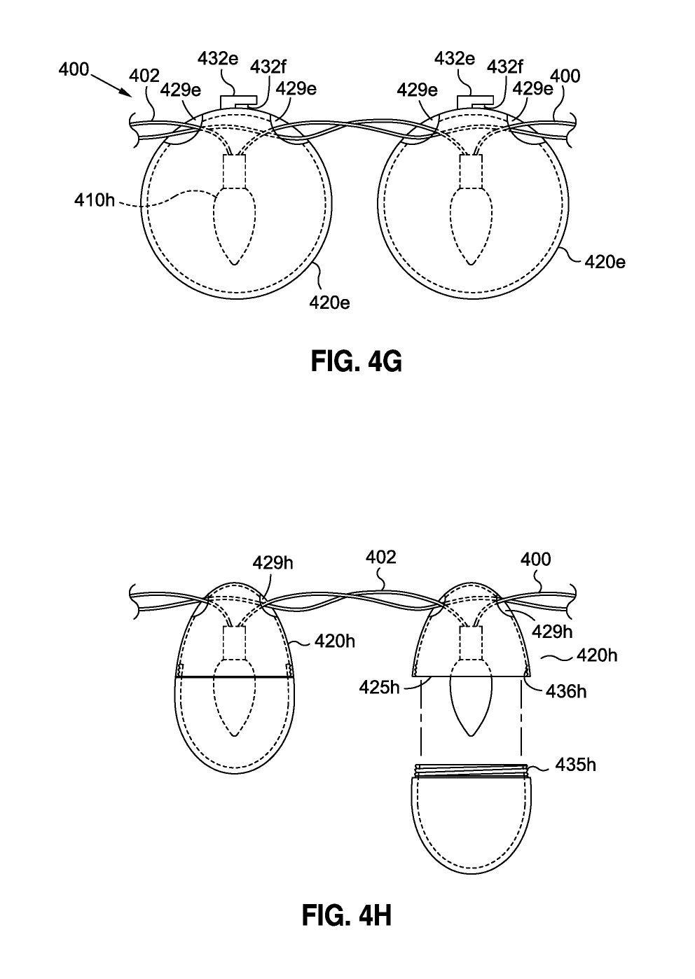

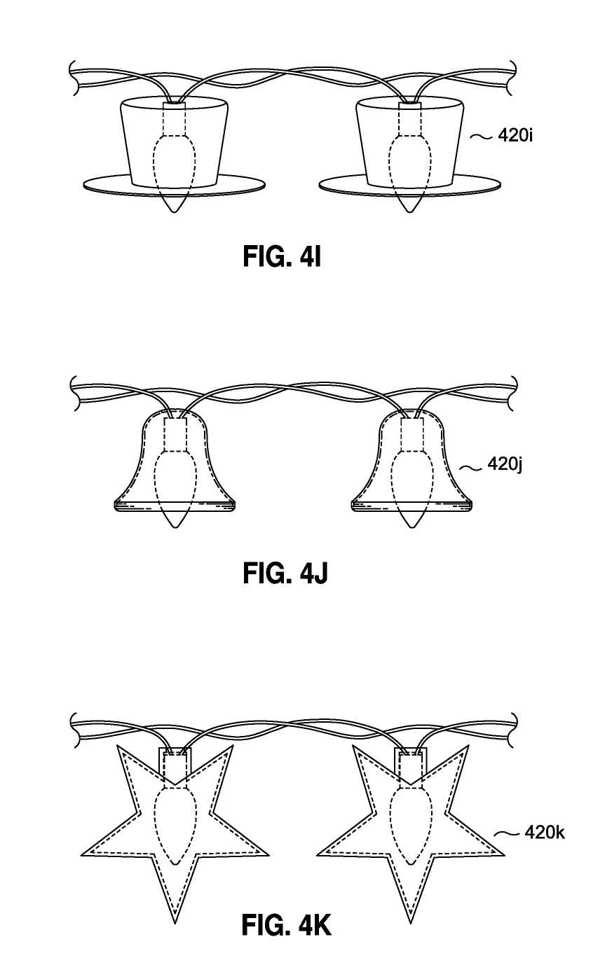

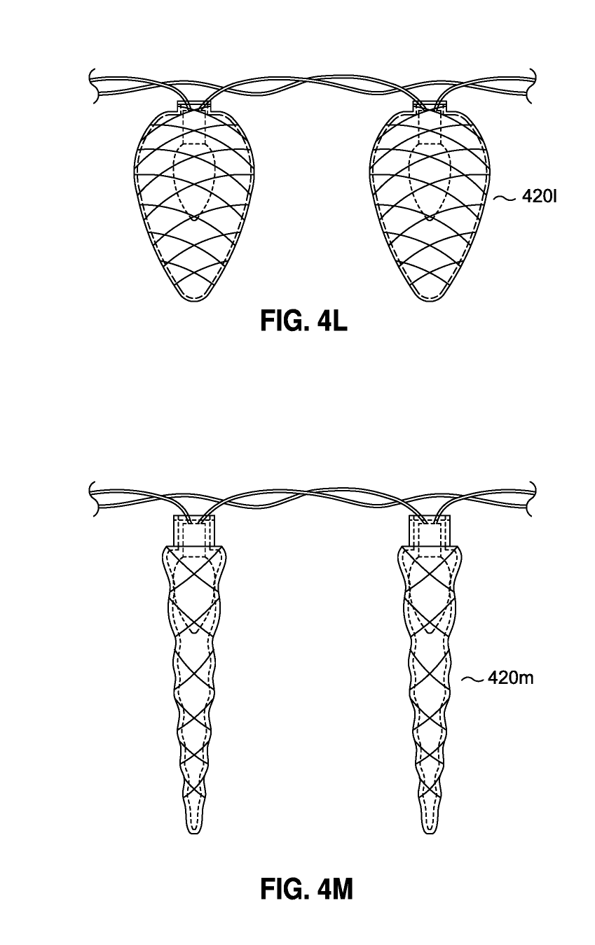

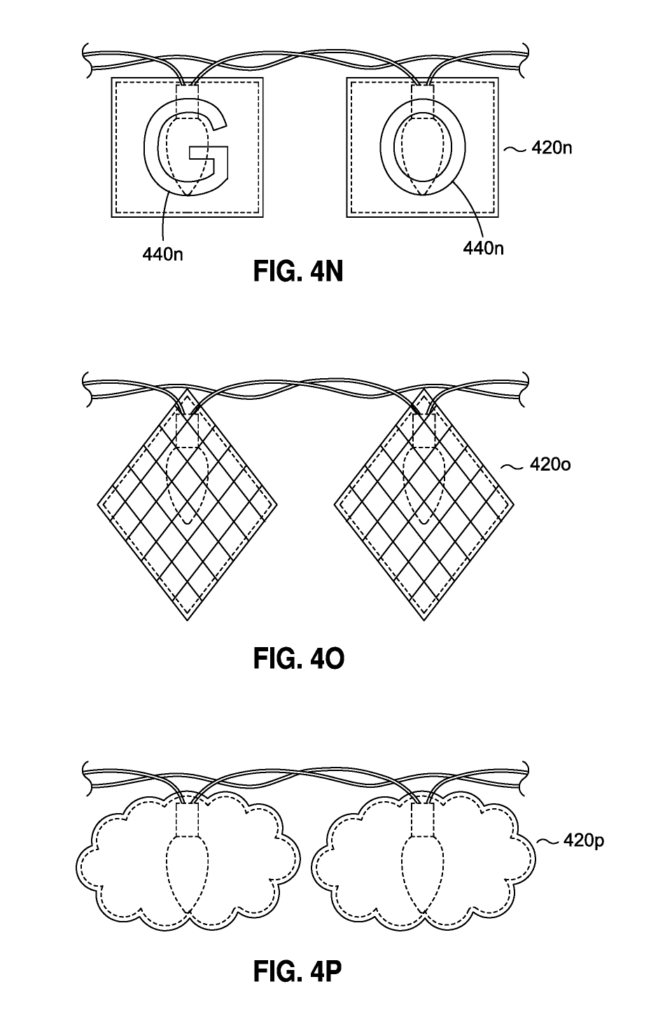

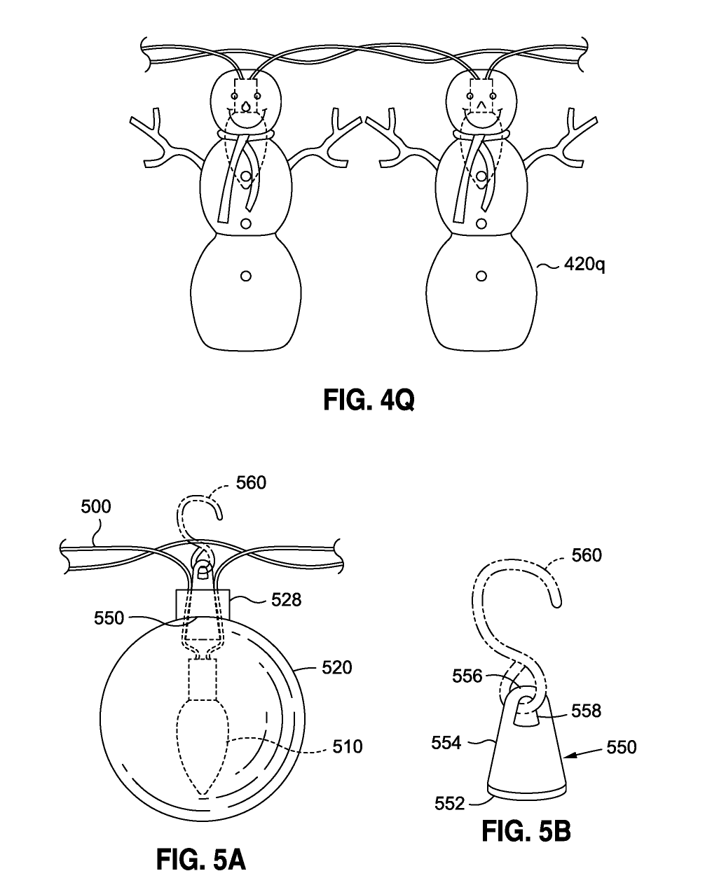

FIGS. 4A-4Q show examples of internally lighted ornaments according to various embodiments of the invention. The different types of ornaments may be used in any combination on a particular strand of holiday lights, or a single type or ornament may be used on a strand of lights. FIG. 4A shows an internally lighted ornament in an open configuration with a latch-type connector. FIG. 4B shows the internally lighted ornament of FIG. 4A in a closed configuration. In this embodiment, the ornament 420a includes a connecting projection 428a that is formed from an outer projection 432a and an inner projection 432b. When in the closed position, the outer projection 432a in configured to wrap partially around the inner projection 432b to hold the ornament 420a in the closed position. The outer projection 432a and inner projection 432b are each formed of a resilient material to facilitate the insertion of the inner projection 432b into the outer projection 432a.

In addition to or alternatively, the ornament 420a includes a latch 427a that extends from the outer surface 422a of the ornament 420a to protrude past the connecting surface 425a of one half of the ornament 420a. When the connecting surfaces 425a are brought into contact with one another in the closed position, the latch 427a engages with a corresponding groove or catch 427b on the outer surface 422a of the ornament 420. The latch 427a and catch 427b releasably hold the ornament 420a in the closed position. Other variations are also possible. For example, the latch could project outward from the connecting surface 425a instead of the outer surface 422a to be inserted into a corresponding hole of the corresponding connecting surface 425a.

As in the embodiment shown in FIGS. 2A-2C, the connecting projection 428a may include a flange (not shown) to hold a light within the interior of the ornament 420a. Of course, any other connector, clamp, clip, adhesive, or the like may be used to hold the light within the ornament 420a to internally light the ornament.

FIG. 4C shows an internally lighted ornament in an open configuration with a magnetic connector. FIG. 4D shows the internally lighted ornament of FIG. 4C in a closed configuration. In this embodiment, the ornament 420c is generally of the same configuration as the ornament 420a. The ornament 420c additionally or alternatively includes at least one magnet 427c and a corresponding magnet 427d or a magnetically attracted material. The magnet 427c and corresponding magnet 427d are disposed at corresponding connecting surfaces 425c of the ornament. In this manner, when the ornament is brought into the closed position where the connecting surfaces 425c are brought together, the magnets 427c, 427d are joined by a magnetic force that releasably holds the ornament 420c in the closed position.

FIG. 4E shows an internally lighted ornament in an open configuration with apertures. FIG. 4F shows the internally lighted ornament of FIG. 4E in a closed configuration. FIG. 4G shows internally lighted ornaments with apertures for wiring. In this embodiment, an ornament 420e includes a releasable connector on a top center of the ornament. The connector is comprised of a projection 432e that extends outwardly from the connecting surface 425e. The projection 432e is received by a corresponding planar surface 432f that includes a rib, indent or other feature to releasable lock the projection 423e in place.

The connecting surface 425e further includes cutouts 434e and 434f in each half of the ornament 420e on either side of the top center of the ornament 420e. When the ornament 420e is placed in the closed position, the cutouts 424e and 424f each define one half of an aperture 429e allowing access to the interior of the ornament 420e.

As shown in FIG. 4G, when the ornament 420e is in the closed position, it may be closed around a wire 402 of the strand 400 of lights. In this manner, a light 410h may be suspended from the wire 402 within the ornament 420e. It is noted that the size of the aperture 429e is configured to facilitate the wire 402, and the actual size may be different that that shown in the Figures. Furthermore, the ornament with the apertures 429e may be combined with any other connection method as described above. As such, the ornament 420e may take on a complete round shape, or may include a projection such as projection 228 in FIG. 2A. For example, the ornament 420e may include a projection similar to projection 228 and a cap such as the cap 240. However, the cap 240 may be fitted with a hanging device instead of the opening 246 to hang the ornament 420e. Other combinations are also possible.

FIG. 4H shows internally lighted ornaments in an egg-type shape with a threaded connector. In this embodiment, an ornament 420h may have a different shape than a traditional spherical ornament. Here, the ornament 420h is shaped similar to an egg. The ornament 420h may be separated into two halves to allow convenient storage, as explained above. In this embodiment, the ornament 420h does not include a hinge, but instead the two halves of the ornament 420h are completely separable.

The ornament 420h includes a threaded connector to releasably attach the two halves of the ornament 420h together. Specifically, one half of the ornament 420h comprises male threads 435h that are received into female threads 436h of the other half of the ornament 420h. The ornament 420h may also include apertures 429h to facilitate the wire 402 of the strand 420, as described above.

In FIGS. 4A-4H, a number of connections and modification to internally lighted ornaments have been explained. It is noted that further modifications or different combinations are also envisaged and are within the scope of the invention.

In addition, ornaments for the strand of lights may include a variety of shapes for different occasions and different user preferences while incorporating one or more of the above-explained features. As a first example, FIG. 4I shows internally lighted ornaments 420i in a hat-shaped configuration. Such hats may be a green color and may be used during St. Patrick's Day. As another example, FIG. 4J shows internally lighted ornaments 420j in a bell-shaped configuration. As yet another example, FIG. 4K shows internally lighted ornaments 420k in a star-shaped configuration. Furthermore, FIG. 4L shows internally lighted ornaments 4201 in a strawberry-shaped configuration. As another example, FIG. 4M shows internally lighted ornaments 420m in an icicle-shaped configuration. In another embodiment, FIG. 4N shows internally lighted ornaments 420n in a cube-shaped configuration. It is noted also in this embodiment that lettering 440n is included on the ornament 420n. The lettering 440n may be substantially opaque to allow a user to create any number of signs using the internally lit ornaments 420n. Such opaque lettering or other decor may be used in any combination with any of the embodiments of ornaments described herein. In yet a separate embodiment, FIG. 4O shows internally lighted ornament 420o in a decorative, diamond-shaped configuration. FIG. 4P shows internally lighted ornaments 420p in a cloud-shaped configuration. FIG. 4Q shows an internally lighted ornament 420q in a snowman-shaped configuration.

The above described embodiments illustrate that the internally lighted ornament may take on any variety of shapes and decor. In each of the above internally lighted ornaments, the ornament is releasably separable into halves to facilitate access to the light as part of the strand of holiday lighting and to allow for easy storage and shipping. Further, each of the ornaments includes a configuration to hold a light within the ornament in the closed position, such as the connecting projection and/or apertures as described above.

In each of the above embodiments, the ornaments are shown to be suspended from the strand of decorative lighting via a base of the light within the ornament or via the wiring of the strand of lights. The ornaments may also have connectors to hang directly from a tree or other structure.

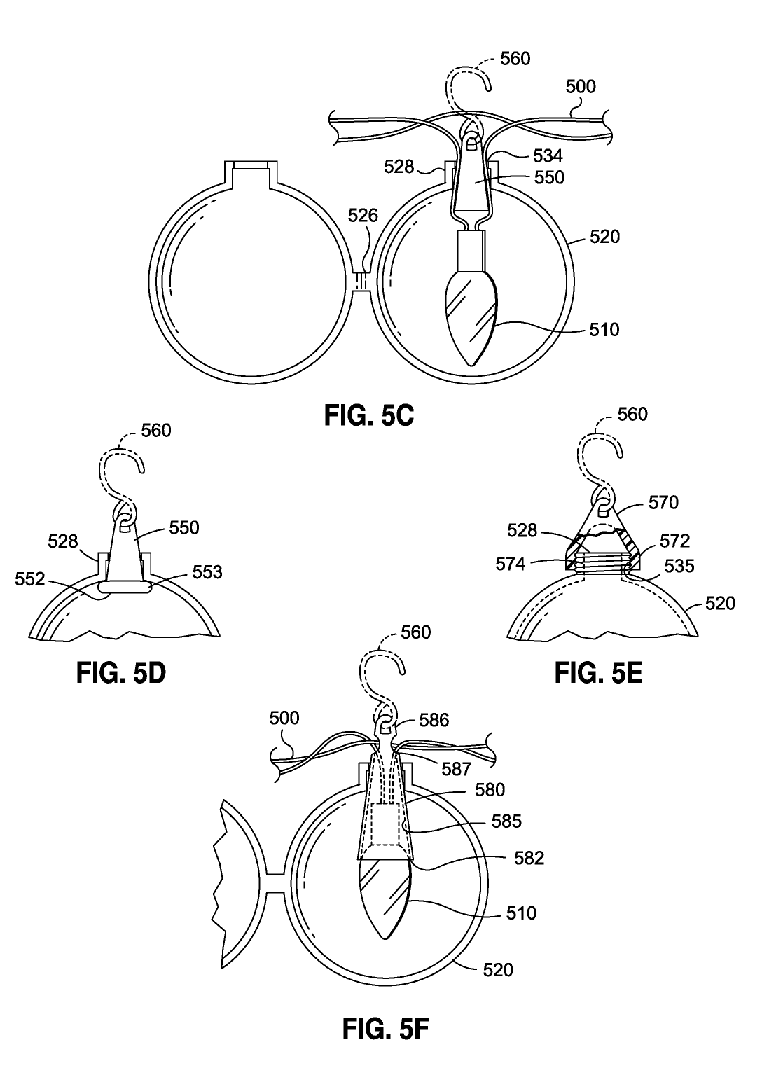

FIGS. 5A-5F show internally lighted ornaments with hanging connectors according to various embodiments. FIG. 5A shows an internally lighted ornament with a plug connector. In FIG. 5A a “plug” 550 is used in conjunction with an ornament 520 that is internally lighted with a light 510. The light 510 may be one of many lights of a strand of lights and thus connected and electrically powered by wiring 500. The plug 550 is configured to extend through the connecting projection 528 of the ornament 520. The plug 550 includes a hanger 560 to hang the internally lighted ornament 520 from a tree, bush, or other structure.

In FIG. 5A, the wiring 500 passes through the connecting projection 528 between an inner surface of the connecting projection 528 and an outside surface of the plug 550. Though not shown, either the inner surface of the connecting projection 528 or the outside surface of the plug 550 may include grooves to facilitate the placement of the wiring 500 through the connecting projection 528 with the plug 550.

FIG. 5B shows an enlarged view of the plug connector shown in FIG. 5A. As shown in FIG. 5B, the plug 550 may be configured to have a wide bottom end 552, a tapered body 554, and a narrow top end 556. In this embodiment, the bottom end 552 of the plug 550 is configured to be wider than an opening of the connecting projection 528. In this manner, when the ornament 520 is in the closed position, the plug 550 may not be removed from the interior of the ornament 520, holding the plug in place. The plug 550 may further include an aperture 558 to facilitate placement of the hanger 560. In an alternate embodiment, the hanger 560 may be formed integrally with the plug.

FIG. 5C shows an exemplary installation of a plug connector shown in FIGS. 5A and 5B. In this embodiment, the light 510 and plug 550 are place in the interior of the ornament 520 when the ornament 520 is in an open position. Specifically, the plug 550 and wiring 500 are placed so as to disposed within the connecting projection 520. The tapered body 554 of the plug 550 allows the plug to be abutted against the inner surface of the connecting projection 520, and may also be abutted against the flange 534. When the ornament 520 is brought into the closed position as described above via the hinge 526, the plug 550 and light 510 are locked within the ornament 520, and the ornament 520 may be hung by the hanger 560 connected to the plug 550.

FIG. 5D shows another exemplary embodiment of a plug type hanging connector. In this embodiment, the plug 550 includes a bottom end 552 with a rib 553 extending from a radial surface of the plug 550. The rib 553 is configured to have a radius greater than an inner radius of the connecting projection 528. The rib 552 may thus further secure the plug 550 within the ornament 520 when the ornament 520 is in the closed position. It is also noted that with the plug 550, with or without rib 553, the ornament may be used as a traditional ornament without the need for internal lighting. Thus the ornament may be versatile to fulfil a user's needs and preferences.

FIG. 5E shows a cap hanging connector according to an exemplary embodiment. In this embodiment, instead of the hanging connector being configured on the inside of the ornament 520, the handing connector is a “cap” connector 570 that is configured to fit over the top of and surround the connecting projection 528 of the ornament 520. The cap 570 may include a hollow bottom portion 572 that surrounds and attaches to an outside surface of the connecting projection 528. In this embodiment, the connecting projection includes male threads 535 that connect to female threads 574 of the of the bottom portion 572 of the cap 570. Other connections now known or later developed may of course be employed to connect the cap 570 to the projection 528. In FIG. 5E, the cap 520 and ornament 520 are shown without a light disposed therein. However, the cap 520 may also be configured with apertures to facilitate the wiring 500 so that a light may disposed with the ornament 520 to internally light the ornament 520.

FIG. 5F shows a hanging connector with internal wiring according to an exemplary embodiment. In this embodiment a plug type hanging connector 580 is configured to be hollow. The area within the connector 580 is defined by an inner surface 585 and is open on a bottom end 582. The top end 586 of the connector also provides access to the hollow interior such as through one or more apertures 587. In this embodiment, the wiring 500 and the light 510 are configured to extend into the hollow area of the connector 580 via the hollow bottom end 582 and apertures 587. A hanger 560 is attached to the top end of the connector 580 and hangs the ornament 520 from a tree or other structure when the ornament 520 is in the closed position surrounding the connector 580. The connector 580 may be formed to be permanently attached to the light 510 on the strand of lights, or may be configured to be removable therefrom. For example, the connector 580 may also have a clamshell type construction similar to the above described ornaments. In other embodiments, the connector 580 may have a slit extending along a side of the connector 580 that allows the wiring 500 to pass in and out of the connector 580.

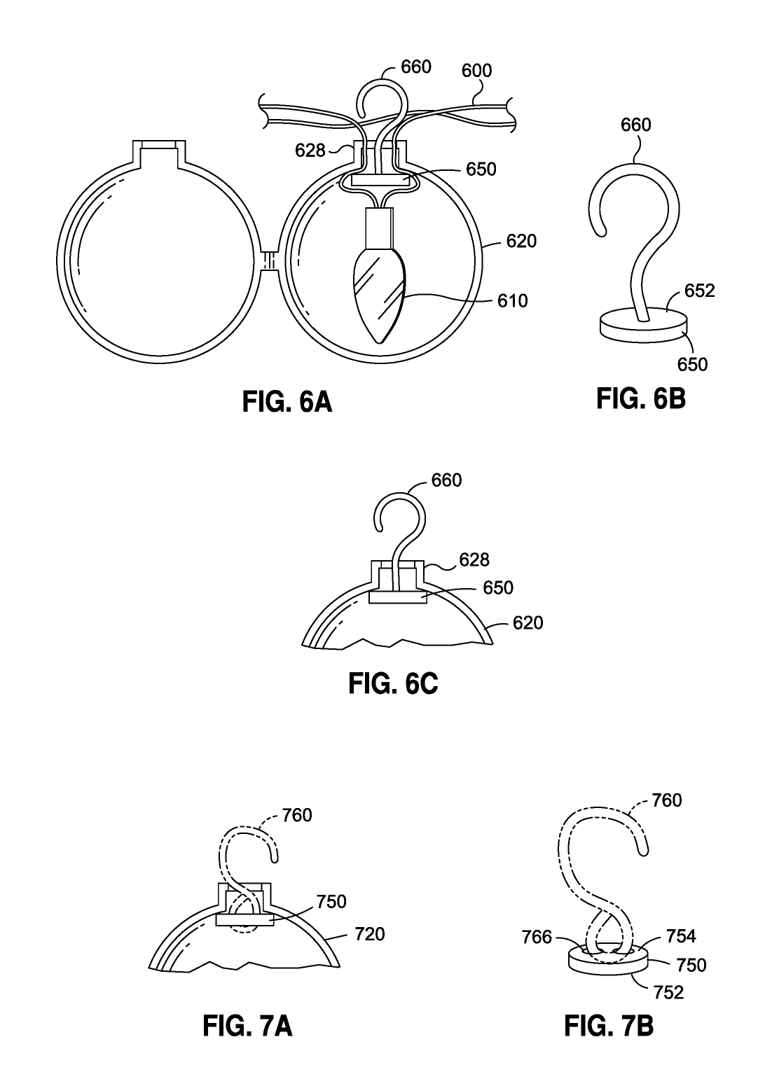

FIGS. 6A-6C show an alternative plug-type connector according to an exemplary embodiment. FIG. 6A shows a plug-type connector with an internally lighted ornament. In this embodiment, the plug-type connector 650 includes a plate 652 that is configured to fit within the ornament 620. The plate 652 has a radius that is larger than the connecting projection 628. Thus, when the ornament 620 is placed in the closed position, the plate 652 is held within the ornament 620. Wiring 600 may extend around the plate 652 and outside of the ornament 620 through the connecting projection 628 to facilitate a light 610 within the ornament 620 to internally light the ornament.

FIG. 6B shows a close up view of the plug-type connector according to FIG. 6A. In this embodiment, the connector 650 is formed such that the plate 652 is formed integrally with a hanger 660. The hanger 660 facilitates the hanging of the ornament from a tree or other structure. The hanger 660 is shown in a hooked shape in FIG. 6. However, the hanger 660 may be any suitable shape including a loop, square, U-shaped, or other workable shape. The hanger 660 might also comprise a clip or clamp to secure the ornament 620 to a structure.

FIG. 6C shows the plug-type connector of FIGS. 6A and 6B with internal lighting omitted. As before, in this embodiment the connector 650 may also allow a user to use an ornament 620 without the light as an ordinary ornament. This increases the versatility of the use of the ornaments.

FIGS. 7A and 7B show an alternative plug-type hanging connector according to an exemplary embodiment. FIG. 7A shows a plug type connector within an ornament. FIG. 7B shows a close up view of the plug-type connector of FIG. 7A. In this embodiment, the connector 750 is a plate structure having an upper surface 754 and lower surface 752. The connector includes two apertures 766 to receive a hanger 760. In this embodiment, the hanger 760 and connector 750 may be more easily manufactured due to the simplicity of the components. Of course, other types of now known or later developed connectors for hanging an ornament may also be employed.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1-20. (canceled)

21. A strand of holiday lights comprising:
a plurality of lights connected by at least one wire, and
a plurality of ornaments, the ornaments having an outer surface and an inner surface defining a hollow space, the ornaments being at least partially transparent, being configured to be releasably separable into two halves, and being configured to receive at least one light of the plurality lights and releasably hold the at least one light within the hollow space to internally light the ornaments,
wherein the ornaments are configured to be nested together in a stored condition.

22. The strand of holiday lights of claim 21, wherein the ornaments further comprise at least one aperture through which the at least one wire extends to the at least one light.

23. The strand of holiday lights of claim 22, wherein the apertures are formed from cutouts in at least one of the two halves.

24. The strand of holiday lights of claim 21, wherein the ornaments further comprise a connecting projection extending from the outer surfaces of the ornaments.

25. The strand of holiday lights of claim 24, wherein a cap is connected over the connecting projection.

26. The strand of holiday lights of claim 25, wherein the cap receives and holds the at least one light within the hollow space.

27. The strand of holiday lights of claim 25, wherein the cap comprises a hanger attached to a top portion thereof, the hanger being configured to suspend the ornament from another object.

28. The strand of holiday lights of claim 21, wherein the two halves are connected by a magnetic connection.

29. The strand of holiday lights of claim 21, wherein the two halves are connected by a latching connection.

30. The strand of holiday lights of claim 21, wherein the two halves are joined by and movable about a hinge.

31. An internally lit ornament comprising:
an at least partially translucent ornament body having an outer surface and an inner surface, the inner surface defining a hollow space, the ornament body comprising two halves that are releasably separable from one another;
at least one aperture configured to receive at least one wire connecting to a light, the hollow space being configured to receive the light therein; and
at least one connector configured to releasably connect the two halves;
wherein the two halves of the ornament retain the light within the hollow space when connected by the connector, and
wherein the two halves are configured to nest within other ornament halves when released by the connector.

32. The internally lit ornament of claim 31, further comprising:
a connecting projection extending from the outer surface of the ornament body, the light being held within the connecting projection, and the at least one aperture being disposed in a top of the projection connection.

33. The internally lit ornament of claim 31, wherein the at least one aperture is formed by a cutout in at least one of the two halves of the ornament body.

34. The internally lit ornament of claim 33, further comprising:
a connecting projection extending from the outer surface, and
a hanger connected to a top of the connecting projection.

35. The internally lit ornament of claim 34, wherein the at least one aperture comprises two apertures disposed on opposite sides of the connecting projection.

36. The internally lit ornament of claim 34, further comprising a cap configured to cover the connecting projection, the hanger connected to the cap.

37. The internally lit ornament of claim 33, wherein the at least one aperture comprises two apertures, the apertures being configured to suspend the light from the wire within the hollow space.

38. The internally lit ornament of claim 31, further comprising an opaque coating partially covering the at least partially translucent ornament body.

39. The internally lit ornament of claim 31, wherein the ornament body has a spherical shape in the closed position.

40. The internally lit ornament of claim 31, further comprising a hinge connecting the two halves of the ornament body.

41. The internally lit ornament of claim 31, wherein the two halves are connected by a latching connection.
